(19) United States
(12) Patent Application Publication
(10) Pub. No.: US 2008/0262863 A1
(43) Pub. Date: Oct. 23, 2008

(54) Integrated, Rules-Based Security Compliance And Gateway System

(75) Inventors: James N. Stickley, La Mesa, CA (US); Robert W. Guba, Baton Rouge, LA (US)

Correspondence Address: JONES, WALKER, WAECHTER, POITEVENT, CARRERE;& DENEGRE, L.L.P., 5TH FLOOR, FOUR UNITED PLAZA, 8555 UNITED PLAZA BOULEVARD, BATON ROUGE, LA, 70809, US

(73) Assignee: TRACESECURITY, INC., Baton Rouge, LA (US)

(21) Appl. No.: 11/908,110

(22) PCT Filed: Mar. 13, 2006
(86) PCT No.: PCT/US06/08913

§ 371 Date: May 5, 2008

Related U.S. Application Data
(60) Provisional application No. 60/660,679, filed on Mar. 11, 2005.

(51) Int. Cl. G06Q 10/00; H04L 9/00; G06F 21/00; H04L 9/32

(52) U.S. Cl. 705/1; 726/1; 726/7

(57) ABSTRACT

Processes which enable regulated enterprises to efficiently manage regulatory compliance of computer networks and their users. One computer-implemented process involves providing a query database having information representing a plurality of queries, each query being associated in the query database with one or more of a plurality of specific industry regulations; receiving a selection of one or more of the plurality of specific industry regulations and displaying one or more of the queries associated with the selected industry regulations to a user of a computer network under the control of a regulated enterprise; receiving and storing one or more answers provided by the user to the one or more queries displayed; providing a report-writing database having information indicative of one or more statements, each of the statements being associated in the report-writing database with at least one answer provided by the user to at least one query displayed to the user; and generating from the report-writing database a compliance report with one or more of the statements associated with the stored answers.

### REFERENCE TO RELATED APPLICATION

A claim is hereby made to the benefits of the priority of U.S. Provisional Patent Application No. 60/660,679, filed on Mar. 11, 2005.

### FIELD OF THE INVENTION

The present invention relates to computer network and data security systems.

### BACKGROUND

With increasing reliance upon computer network systems vulnerable to third party attack or intrusion, government agencies, publicly traded enterprises and regulated industries are under increasing levels of scrutiny from the public and from relevant regulatory agencies, at least in part due to new laws and regulations attempting to address privacy and computer security concerns. In the United States, for example, legislation and regulations which have had, are having and will have this effect include, e.g., the Sarbane-Oxley Act of 2002, the Graham-Leech-Bliley Act, the Health Insurance Portability and Accountability Act of 1996 (HIPAA), the Fair and Accurate Credit Transactions Act (FACT Act), the Electronic Signatures in National and Global E-Commerce Act (E-Sign), regulations and guidelines promulgated by, e.g., the SEC, FFIEC, OTC, FDIC, and the OCC, amongst others, as well as applicable international standards, e.g., Basel II. In addition, there are widely applicable standards for network security which have been developed, e.g., COBIT, NIST and ISO 17799, and enterprises doing, or seeking to do, business in certain jurisdictions or industries may find it necessary to comply with such standards. Within this environment, organizations affected by these laws, regulations and standards are under pressure to implement and continually update security policies and procedures in verifiable compliance with those laws, regulations and standards, hopefully without unduly increasing operational costs.

A need therefore exists for an efficient way to develop, implement and update policies and procedures which comply with evolving laws, regulations and standards, throughout an organization, across both the human resources of the organization and all potentially vulnerable computer systems of the organization. A need also exists for a way to verify whether the organization's human and computer network resources are in compliance with implemented and updated policies and procedures so that, when non-compliance is discovered though the verification process, a remedy is quickly implemented to reduce or eliminate data vulnerability. A way to efficiently and accurately report policy and regulation compliance analysis to management of regulated enterprises is also needed.

### SUMMARY OF THE INVENTION

The present invention satisfies these and other needs by providing, amongst other things, a method comprising

building a network and data security policy database from organization-specific policy data;

distributing over an electronic network all or some of the policy data in the policy database to one or more authorized users of the electronic network in such a way so as to track the reading and understanding of that which is distributed to the one or more authorized users;

distributing all or some of the policy data in the policy database to one or more computer assets in operative connection with the electronic network;

detecting the computer assets on the electronic network to thereby build an inventory of those computer assets and their particular configurations, respectively;

monitoring the computer assets and the authorized users to test compliance with the distributed policy data; and

restricting or prohibiting connection to or use of the electronic network by those computer assets and authorized users who are not in compliance with the distributed policy data.

As used herein, “computer assets,” includes all manner of hardware, or hardware/software combinations, capable of processing electrical signals.

In another embodiment of the invention, there is provided a method by which hardware attempting to log onto an electronic network is validated by making a comparison between the identified MAC address and the hard drive ID number of the hardware attempting to log on, with a database of MAC addresses and hard drive ID numbers for known and authorized hardware. In another embodiment, the authorized hardware settings are then inventoried and compared to an existing set of distributed network and data security policy data, and if not in compliance with the distributed policy data, reconfigured so as to be in compliance with the distributed policy data.

Still another embodiment of this invention provides a process comprising

providing a query database comprised of information representing a plurality of queries, each query being associated in the query database with one or more of a plurality of specific industry regulations;

receiving a selection of one or more of the plurality of specific industry regulations and displaying one or more of the queries associated with the selected industry regulations to a user of a computer network under the control of a regulated enterprise;

receiving and storing one or more answers provided by the user to the one or more queries displayed;

providing a report-writing database comprised of information indicative of one or more statements, each of the statements being associated in the report-writing database with at least one answer provided by the user to at least one query displayed to the user; and

generating from the report-writing database a compliance report comprised of one or more of the statements associated with the stored answers. In one version of this process, the answers received are indicative of whether the regulated enterprise is in compliance with the specific industry regulations associated with the queries to which answers are provided by the user. In another version, the process further comprises

providing a network and data security policy database for receiving and storing data comprised of enterprise-specific policy data;

distributing over the network all or some of the policy data in the policy database to one or more users of the network;

storing acceptance data indicative of the acceptance, by the one or more users of the network, of policy data distributed over the network; and

displaying the acceptance data to at least indicate a level of policy data acceptance.

These and other embodiments, features and advantages of the present invention will be even further apparent from the ensuing detailed description, the accompanying drawings and the appended claims.

### SUMMARY OF THE DRAWINGS

FIG. 1 is a flowchart diagram of a security compliance management process of one embodiment of the present invention.

FIG. 2 is a flowchart diagram amplifying a policy development component of the process of FIG. 1.

FIG. 3 is a functional block diagram of a computer network of one embodiment of the present invention using INT processors.

FIG. 4 is a functional block diagram of the network of FIG. 3, amplifying upon the functions of the on-site server component thereof.

FIG. 5 is a functional block diagram of the network of FIG. 3, amplifying upon the functions of the main database server component thereof.

FIG. 6 is a flowchart diagram of the ARP signal processing carried out in the embodiment of FIG. 3.

FIG. 7 is a workflow diagram of one aspect of an embodiment of this invention in which computer assets are monitored for policy compliance using vulnerability scanning employing simulated third party attacks.

FIG. 8 is a workflow diagram of another aspect of the embodiment of FIG. 7 in which known computer hardware and/or software exploits and recommended patches or fixes are matched to the actual computer assets on a computer network being monitored and assessed for vulnerabilities to exploits.

FIG. 9 is a workflow diagram of the embodiment of FIG. 7 in which enterprise-specific policies are maintained and distributed to, and monitored for acceptance by, users of the computer network.

FIG. 10 is a workflow diagram of the embodiment of FIG. 7 in which regulation-specific compliance surveys (e.g., groups of queries) are entered into a database and selected for distribution to and response from an enterprise authority, in order to assess enterprise compliance with applicable regulations.

Like letters or numerals are used to refer to like parts or components amongst the several figures.

### DETAILED DESCRIPTION OF THE INVENTION

Typically, the practice of embodiments of the present invention is undertaken through the use of various forms of information technology. For example, in one embodiment of this invention, a software system running on one or more computer network servers is implemented to practice a process of this invention. Embodiments within the scope of the present invention also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions.

Embodiments of the invention are described in the general context of method steps, which may be implemented in one embodiment by a program product including computer-executable instructions, such as program code, executed by computers in networked environments. Generally, program products include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Embodiments of the present invention may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices. Furthermore, databases described herein as part of the present invention may be stand-alone databases or distributed database systems comprising a plurality of databases connected to or accessible by a common processor.

Software and web implementations of the present invention could be accomplished with programming techniques with rule based logic and other logic to accomplish the various database searching steps, correlation steps, comparison steps, calculation steps and decision steps. It should also be noted that the word “component” as used herein and in the claims is intended to encompass implementations using one or more lines of software code, and/or hardware implementations, and/or equipment for receiving manual inputs.

In one embodiment of the invention, the various participants may each utilize a general purpose computer system connected to an electronic network, such as a computer network. The computer network can also be a public network, such as the Internet. By way of example, the computer system may include a central processing unit (CPU) connected to a system memory. The system memory typically contains an operating system, a BIOS driver, and application programs. The application programs include one or more calculation routines for calculating various values for various parameters to be discussed hereinafter using appropriate algorithms. The application programs provide appropriate application programming interfaces (API) through which the relevant calculations and communications can be implemented. Additionally, the application programs may access various distributed external databases. In addition, the computer system contains input devices such as a mouse and a keyboard, and output devices such as a printer and a display monitor. The computer system generally includes a communications interface, such as an ethernet card, to communicate to the electronic network. Other computer systems also connect to the electronic network which can be implemented as Wide Area Network (WAN) or as a public network such as the Internet. One of skill in the art would recognize that the above system describes the components of a computer system connected to an electronic network. It should be appreciated that many other similar configurations are within the abilities of one skilled in the art and all of these configurations could be used with the method of the present invention. Furthermore, it should be recognized that the computer system and network disclosed herein can be programmed and configured, by one skilled in the art, to implement the method steps discussed further herein.

For the present application, “API,” or application programming interface, is a library of programmatic methods provided by a system of some kind (an example is a web-based imaging system) that enables client programs (web content operating within the browser is one example) to interact with that system. One method of creating an API is to create a library. For example, in Java, a library (conventionally called a jar file) is created by defining a class or classes, compiling the class or classes, and grouping the class or classes into a library.

Note that communication methods between entities and entity systems can be implemented using a variety of methods ranging from direct contact with a system computer via an appropriate API, direct contact over the Internet to a host server computer for the entity via a TCP/IP protocol, and optionally on the Web using the HTTP protocol, normal telephone calls to a representative, faxes, e-mails, third-party customer representatives in a bank or other institution.

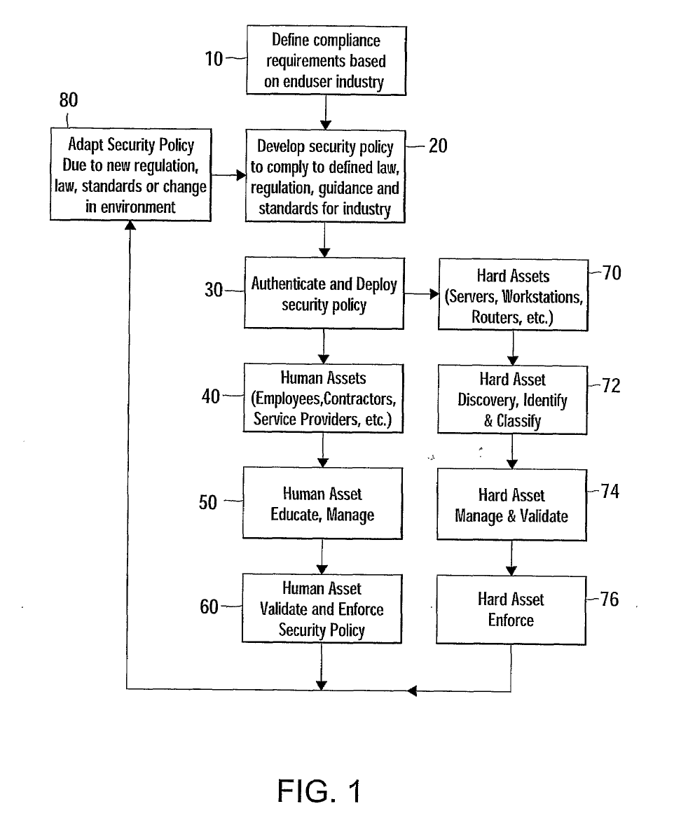

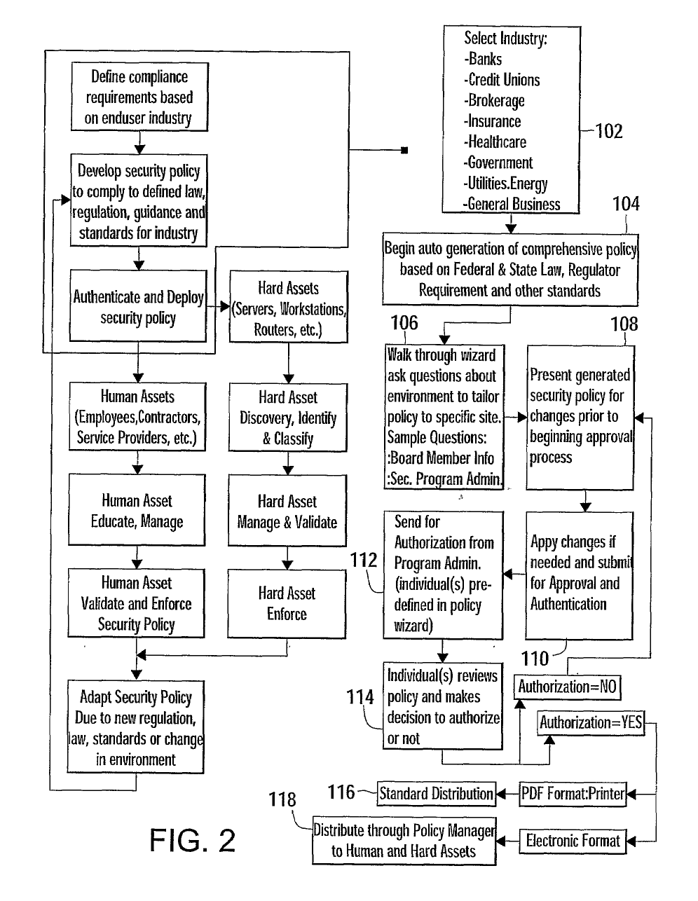

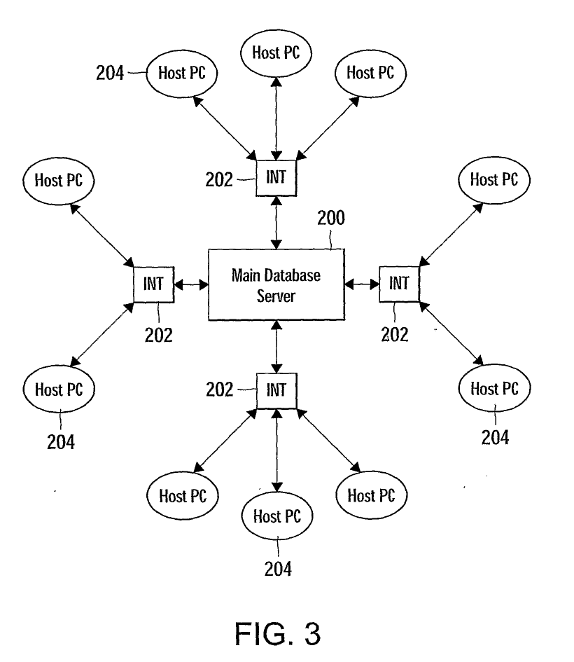

Specific, exemplary embodiments of this invention shall now be seen with reference to the accompanying drawings. FIG. 1 illustrates an organizational-specific network and data policy development, deployment, management and enforcement cycle of one process embodiment of this invention. Thus, an initial step (block 10) involves defining compliance requirements based upon the end user organization's specific industry. From these requirements, the next step (block 20) is conducted by developing security policy to comply with the defined legal, regulatory and standard requirements for the relevant industry. The policy so developed is then authenticated (block 30) and deployed (blocks 40 and 70). The policy is distributed to human assets (block 40) such as, e.g., employees, contractors, service providers, etc. having some relationship with the organization. See also FIG. 3. Human assets are educated on the policy data through an educational process (block 50) implemented through software which also validates and enforces (block 60) the policy through testing and electronic network access or use restrictions when the human user fails testing. The policy is also deployed to the hard assets (block 70), also referred to herein as computer assets. This deployment of policy data will first require, typically, that the hard assets be identified and classified (block 72), validated and maintained (block 74) and if non-compliant, made subject to policy enforcement (block 76), for example, through disconnection or otherwise being made network-disabled. The cycle is completed by updating or revising (block 80) the policy data in the policy database when new legislation, regulation or standards dictates a change in policy data. For the embodiment depicted, the steps of preliminary policy development through deployment to human and computer (hard) assets is further illustrated in FIG. 2. There it can be seen that the first step is to select the industry applicable to the enterprise (block 102). Based upon this selection, the software system may be configured to generate (block 104) a draft policy based upon the regulations applicable to the selected industry. The system then further tailors this draft policy by asking a series of questions to a user (block 106) for input regarding specific information about the enterprise (e.g., management and ownership structure which may determine applicability of specific policies). A draft policy output (block 108) and editing (block 110) and approval (blocks 112 and 114) until approved, and then the approved policy is distributed via printout (block 116) or electronically (block 118). Of course, in other embodiments of this invention, the policies will be developed within the enterprise conventionally without the use of this particular feature.

The process of policy development, distribution and implementation carried out as illustrated in FIGS. 1-2 can be carried out in large part through a computer program, with user input through a software program/computer interface. Thus, for example, in one embodiment the policy database resides on a central main database server 200 as illustrated in the functional block diagram of FIG. 3. There it can be seen that server 200 is in operative connection with a plurality of host PCs 204 and, in some embodiments of the present invention, a plurality of intermediate processors 202 (further described below). Main database server 200 may be a single appliance or may be comprised of two or more separate servers (e.g., web server, application server, database server) performing separate functions.

### Policy Databases

Typically, the policy data in the network and security policy database maintained within systems of the invention may be comprised of information such as, e.g., data representing individual policy documents or statements, regulations, security requirements, network configurations, and operational procedures developed by the regulated entity or customer. Industry-specific regulations or groups of regulations from one or more regulating governmental agencies may be employed to determine the scope and nature of the policy data in the network and data policy database. Regulated industries may include, e.g., banking, finance, healthcare, and legal, amongst others. Non-limiting examples of regulations would include, in the United States, the Sarbane-Oxley Act of 2002, the Graham-Leech-Bliley Act, the Health Insurance Portability and Accountability Act of 1996 (HIPAA), the Fair and Accurate Credit Transactions Act (FACT Act), the Electronic Signatures in National and Global E-Commerce Act (E-Sign), bank secrecy acts, acts related to national security, regulations and guidelines promulgated by, e.g., the SEC, FFIEC, OTC, FDIC, and the OCC, amongst others, as well as applicable international standards, e.g., Basel II. Such policy data will of course vary upon the enterprise and the applicable regulations. One of many examples of such a policy of relevance in the U.S. banking industry would be a suspicious activity report (SAR) filing policy.

### Distribution of Policies

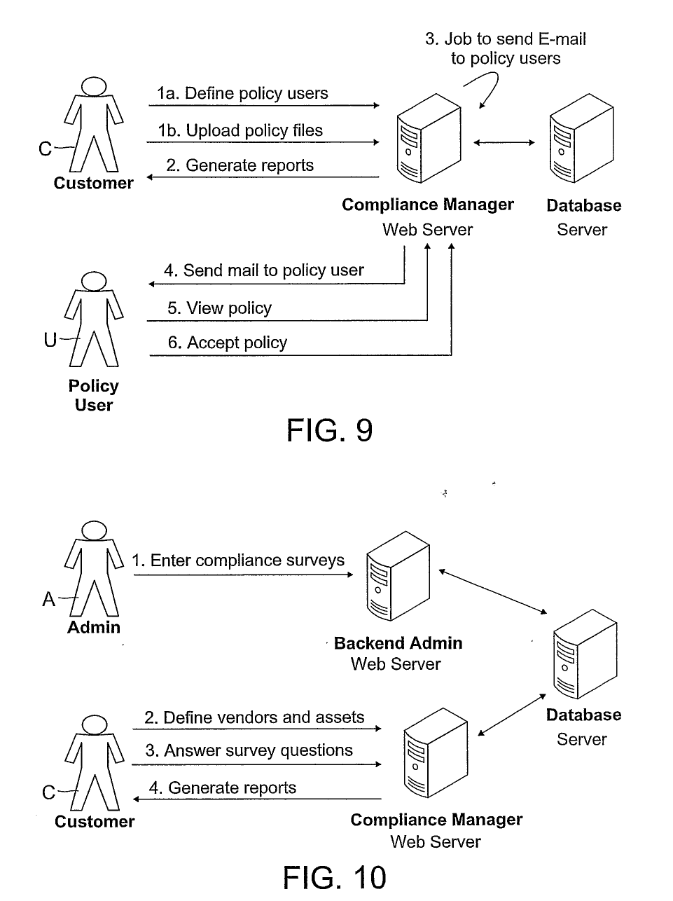

Distribution of policy data to users in certain embodiments of the invention, when automated, is carried out by inputting enterprise-specific policy information into a network and data security policy database for receiving and storing data comprised of enterprise-specific policies. A workflow diagram of one embodiment of this invention which undertakes this distribution is set forth in FIG. 9. There, a customer C inputs the policy data and defines policy users to a compliance manager web server in operative connection to a database server. The policies so entered are electronically made available in this embodiment to a policy user U of the enterprise computer network through, e.g., an intranet web page through the compliance manager web server. The user U is preferably prompted (e.g., via email) to indicate via the web page whether the policy is accepted by the user, and the acceptance data entered by user U is stored in a database within the system. This stored acceptance data for each user across the enterprise or within groups within the enterprise is then made available for display to others seeking to obtain information about the level of policy acceptance within the enterprise.

In other embodiments of the present invention, the system is configured to further track the reading and understanding of distributed policy data through policy-specific surveys users are prompted to complete. The status and/or accuracy of survey completion by users may be monitored in essentially real-time, providing a system for automated compliance and policy training of human assets and monitoring of the same.

### System Monitoring

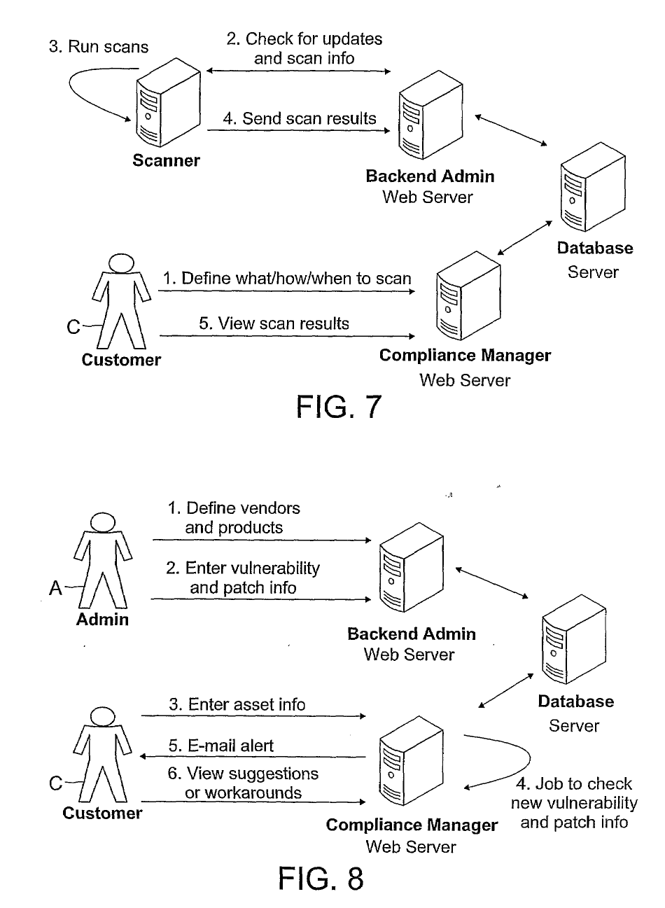

Computer assets on the computer network may be monitored for security vulnerabilities through the use of one or more local or remote scanner servers in operative connection to the network and configured to scan ports and system vulnerabilities. While a variety of software tools may be used to configure such scanners, Nessus and NMap are examples of scanning software tools employed in the scanner servers of a particular embodiment of this invention. An example of workflow typical in use of a system of this invention employing scanner servers is illustrated in FIG. 7, where it can be seen that a customer C will define what, how and when to scan of the network computer assets through data entry into, in this example, a compliance manager web server in operative connection with a database server and a backend administration web server. Each scanner will check for signature updates and scan information, run scans and send scan results to the backend administration server as indicated. Scan results will then be viewed by customer C through interface with the compliance manager web server.

Assets determined to be out of compliance from scanning results periodically or randomly obtained may be manually reconfigured or disabled from the network. The system itself may also be configured to control non-compliant computer assets as further described below in another embodiment of this invention.

The system may also be configured to enable software and hardware vulnerability assessment and maintenance through distribution of patch and fix information. Thus, as seen in FIG. 8, the workflow of the system of FIG. 7 can include the steps of an administrator A defining vendors and products on the network's computer assets, and entering patch and vulnerability information into the server group. Customer C will enter computer asset information (e.g., hardware specifications, software programs installed, etc.) into the server group, and the compliance manager component of the server group will check new vulnerability and patch info on a period or ad hoc basis, to thereby send email notification alerts of the same to customer C. Customer C will also have available for viewing suggestions or workarounds for fixing or patching identified vulnerabilities.

### Compliance Surveys

The query database employed in certain embodiments of the present invention will be comprised of queries and information about the specific regulation(s) necessitating an answer to each of those queries. An example workflow diagram of this process employed on a system of this invention is illustrated in FIG. 10. Administrator A enters a selection of regulations or groups of industry-specific regulations with which compliance is sought. Customer C inputs into the server group indicated the vendors and enterprise asset information, answers the questions posed based upon the survey selections made by administrator A, and can generate reports based upon the answers supplied by customer C. In one particular embodiment, the answer choices may be limited to indicate whether the enterprise is compliant, partially compliant, noncompliant or not applicable to the queries posed. The software may be configured to display a series of queries from the query database based upon the regulations or groups of regulations an administrator indicates to the system are applicable to the user's specific enterprise. In a particular embodiment of this invention, this indication may be obtained by first displaying a listing of regulations, categorized by, e.g., industry or the name of the applicable law or regulating body, and prompting the user to make a category selection. Answers provided to the displayed queries are then received and stored. These answers may be used, e.g., in later generating a report summarizing the compliance status of the enterprise with respect to the queries associated with the selected regulations or groups of regulations associated with the industry of the enterprise.

### Reporting

The report-writing database of certain embodiments of the invention includes information indicative of one or more statements, each being associated in the report-writing database with an answer provided by the user to at least one query displayed to that user. The statements may be single word or multiword phrases, entered by an administrator or pre-packaged into the system of the invention. From this report-writing database and the answers provided by the user and stored in the system, a report on regulatory compliance is generated by compiling the statements from the report-writing database associated with the stored answers.

### Host Monitoring and Control

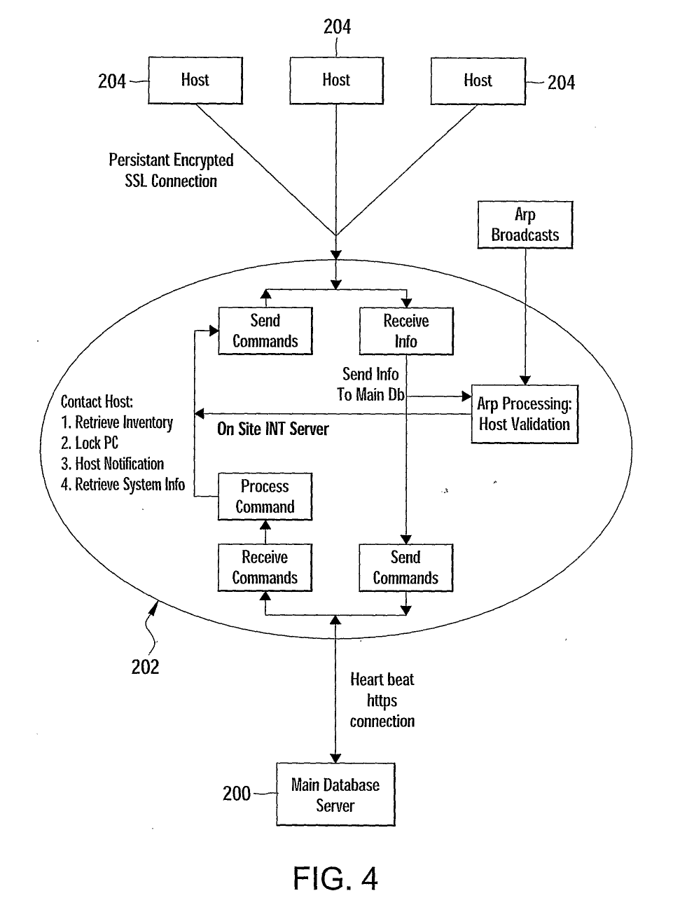

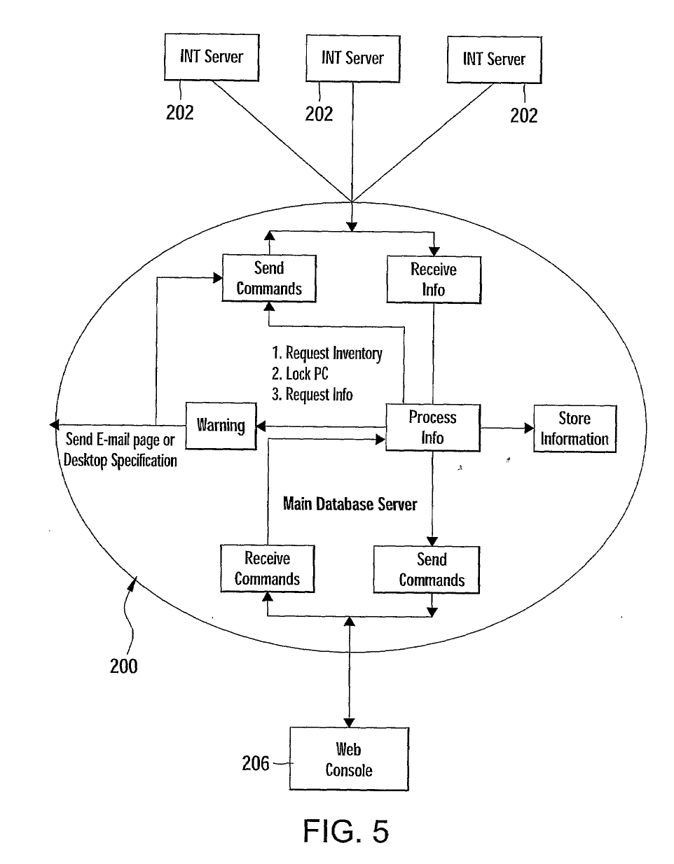

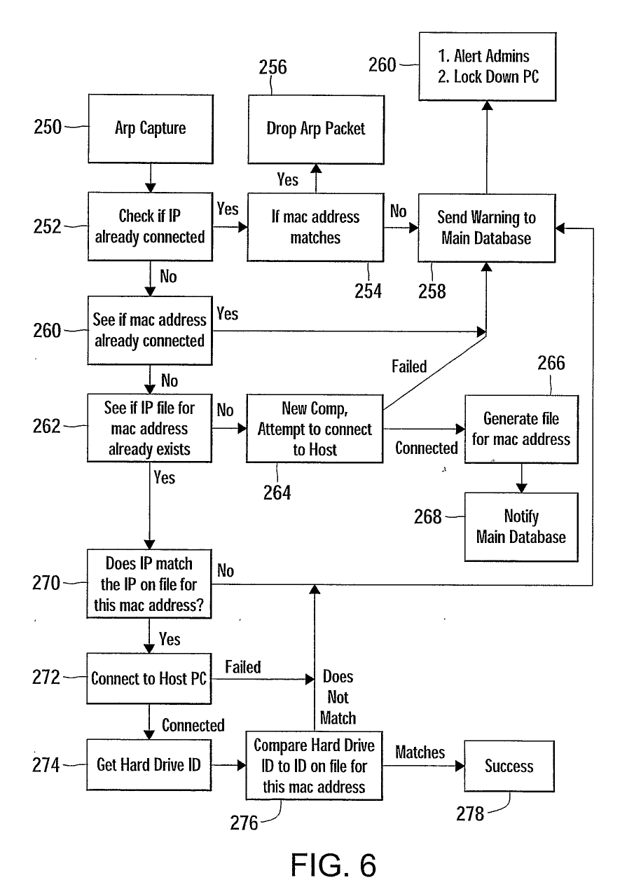

In another embodiment of the invention, a host software application also is installed on each host personal computer (“Host pc”) and communicates with at least one intermediate (“INT”) processor which is in operative connection with the central server. By having multiple INT processors in the network, the network architecture can be segmented to enable zone-like control and monitoring of the hard assets on the network. The INT processor functions to police the hard asset hosts for policy compliance through a combination of validation using ARP signal processing, host notification processing and central server signal processing, all as summarized in the functional block diagram of FIG. 4. Each INT processor 202 on the network is in operative connection to the central or main database server 200, through which commands are sent and received by both. When the connection to server 200 is via the Internet, the connection is maintained using a secure HTTP connection. The host PCs 204 preferably have a persistent encrypted SSL connection to INT processor 202 for transmitting information to the INT processor 202 and receiving commands therefrom. INT processor 202 processes ARP broadcasts from the host PCs 204 in order to validate them. The main database server 200 receives and processes information and sends commands to each INT processor 202 as illustrated in the functional block diagram of FIG. 5. The server 200 as illustrated may be administered through a web-based console 206, and can notify administrators of noncompliance events or other security violations through output signals to email, pagers, computers or the like. The ARP and other processing conducted by the intermediate processor (INT) acts to police hard assets attempting to log onto the network and to enforce policy data requirements on that portion of the network for which the intermediate processor (INT) serves as a gateway. The processing of the ARP signal by this particular embodiment upon ARP signal capture is outlined in the flowchart diagram of FIG. 6. There is illustrated the process of comparing the IP address, hard drive ID and MAC address information captured against stored database information of authorized computer asset information on the network. Upon ARP capture (block 250), a check is made against database information to see if the IP address is already connected to the network (block 252), and if it is and the MAC address matches that in the database (block 254), then the ARP packet is dropped from further processing (block 256). If the IP address is not already connected, the database is further queried to determine if the MAC address is already connected (block 260), and if so, a warning is sent to the main database (block 258) and the admin is alerted and/or the PC is locked down (block 260). If the MAC address is not already connected and the IP address is not already connected, another query is made to determine if the IP file for that MAC address already exists (block 262). If it does, a comparison is made to determine if the IP address matches the IP address on file for that MAC address (block 270), and if not, the warning, alert and/or lockdown of blocks 258 and 260 are conducted. If the IP address does match the IP address on file for the MAC address, an attempt is made to connect to the host PC (block 272), and if it succeeds, the hard drive ID is obtained (block 274) for a comparison of it to the ID on file for that MAC address (block 276). If the hard drive ID does match the ID on file for that MAC address then the asset from which the ARP signal originated is validated (block 278). If an IP file for the MAC address never existed (per block 262), the ARP signal is determined to be from new hardware, and an attempt is made to connect to the host (per block 264). If that connection is made, an IP file is generated for that MAC address (block 266) and the main database is notified (block 268). If no connection can be made, the warning, alert and/or lockdown of blocks 258 and 260 are conducted.

It should be appreciated that the software which resides upon the host PCs, the intermediate processor (INT) and/or the central server(s), can be authored using a variety of programming languages, but a program representing a distributed database application written in a standard markup language such as Java™, ColdFusion™ and/or HTML, with extensions allowing for interactive processing is sometimes preferred. The software may also be implemented using a stand-alone central server or group of servers, a server solution implemented over the Internet via an application service provider (ASP), or any combination of the foregoing. Open secure socket layer connections between the INT processor, if employed, may be maintained. When a lockdown of a computer asset is required, this is conveniently implemented by the software code residing on the Host PC to be locked, in certain embodiments of the invention. When employed, the host PC software is preferably configured to police for and to signal non-compliance to the INT processor. The INT processor, when employed, may also be configured to kill Internet connections for detected, unidentified computer assets.

It should be apparent that the foregoing detailed description of certain embodiments of the present invention is illustrative in nature and is not intended to be completely exhaustive of all possible embodiments of the invention. Accordingly, the invention should not be construed to be limited to the foregoing exemplary embodiments, but should be construed to be all subject matter which falls within the literal scope of the appended claims, and all of the equivalents thereof, to the extent permitted by applicable law.

1. A process comprising
providing a query database comprised of information representing a plurality of queries, each query being associated in the query database with one or more of a plurality of specific industry regulations;
receiving a selection of one or more of the plurality of specific industry regulations and displaying one or more of the queries associated with the selected industry regulations to a user of a computer network under the control of a regulated enterprise;
receiving and storing one or more answers provided by the user to the one or more queries displayed;
providing a report-writing database comprised of information indicative of one or more statements, each of the statements being associated in the report-writing database with at least one answer provided by the user to at least one query displayed to the user; and
generating from the report-writing database a compliance report comprised of one or more of the statements associated with the stored answers.

2. A computer-readable medium encoded with a computer-executable software program for carrying out a process in accordance with claim 1.

3. A process according to claim 1, wherein the answers received are indicative of whether the regulated enterprise is in compliance with the specific industry regulations associated with the queries to which answers are provided by the user.

4. A computer-readable medium encoded with a computer-executable software program for carrying out a process in accordance with claim 3.

5. A process according to claim 1, further comprising
providing a network and data security policy database for receiving and storing data comprised of enterprise-specific policy data;
distributing over the network all or some of the policy data in the policy database to one or more users of the network;
storing acceptance data indicative of the acceptance, by the one or more users of the network, of policy data distributed over the network; and
displaying the acceptance data to at least indicate a level of policy data acceptance.

6. A computer-readable medium encoded with a computer-executable software program for carrying out a process in accordance with claim 5.

7. A process comprising
providing a network and data security policy database for receiving and storing data comprised of organization-specific policy data;
distributing over an electronic network all or some of the policy data in the policy database to one or more authorized users of the electronic network in such a way so as to track the reading and understanding of that which is distributed to the one or more authorized users;
distributing all or some of the policy data in the policy database to one or more computer assets in operative connection with the electronic network;
detecting the computer assets on the electronic network to thereby build an inventory of those computer assets and their particular configurations, respectively;
monitoring the computer assets and the authorized users to test compliance with the distributed policy data; and
restricting or prohibiting connection to or use of the electronic network by those computer assets and authorized users who are not in compliance with the distributed policy data.

8. A process comprising validating a computer which is attempting to log on to an electronic network by receiving an identified MAC address and a hard drive ID number of the computer, and comparing the identified MAC address and the hard drive ID number of the computer attempting to log on with a database of MAC addresses and hard drive ID numbers for known and authorized computer hardware.

9. A computer-readable medium encoded with a computer-executable software program for carrying out a process in accordance with claim 8.

10. The process of claim 8, further comprising
making an inventory of the settings of a validated computer and comparing the inventory to an existing set of distributed network and data security policy data to determine whether one or more validated computer settings is not in compliance with the network and data security policy data.

11. A computer-readable medium encoded with a computer-executable software program for carrying out a process in accordance with claim 10.

12. The process of claim 10, further comprising
reconfiguring the one or more validated computer settings identified as noncompliant so as to conform those validated computer settings to the distributed network and data security policy data.

13. A computer-readable medium encoded with a computer-executable software program for carrying out a process in accordance with claim 12.
